(19) United States
(12) Patent Application Publication
(10) Pub. No.: US 2025/0234197 A1
(43) Pub. Date: Jul. 17, 2025

(54) AUTOMATED CERTIFICATE-BASED DEVICE ENROLLMENT SYSTEM

(71) Applicant: Cisco Technology, Inc., San Jose, CA (US)

(72) Inventors: Mark Grayson, Maidenhead (GB); Bart Brinckman, Nevele (BE); Edward Thomas Lingham Hardie, Los Gatos, CA (US)

(21) Appl. No.: 18/943,694

(22) Filed: Nov. 11, 2024

Related U.S. Application Data
(60) Provisional application No. 63/621,518, filed on Jan. 16, 2024.

(51) Int. Cl. H04W 12/069

(52) U.S. Cl. CPC H04W 12/069

(57) ABSTRACT

Disclosed are systems, apparatuses, processes, and computer-readable media for automated certificate-based device enrollment system. For example, a disclosed method includes receiving, by a client device, a certificate signed by a certificate authority, the certificate including network credential information associated with a wireless network; in response to enabling a client supplicant, configuring a credential of the client device based on the certificate and the network selection credential information; using the configured credential to trigger the automatic network detection and selection of a wireless network; and authenticating with the wireless network using the credential.

### CROSS-REFERENCE TO RELATED APPLICATIONS

This application claims the benefit of U.S. provisional application No. 63/621,518, filed on Jan. 16, 2024, which is expressly incorporated by reference herein in its entirety.

### TECHNICAL FIELD

The disclosure relates generally to wireless networking, and more specifically an automated certificate-based device enrollment system.

### BACKGROUND

Passpoint, also known as Hotspot 2.0, is an IEEE 802.11 authentication technology designed to simplify and secure the connection process for users. It was developed by the Wi-Fi Alliance based on the IEEE 802.11u protocol and allows devices to, after an initial authentication, to automatically connect to available Passpoint-certified Wi-Fi hotspots without additional authentication attempts, or Wi-Fi network configuration, as users move between access points in a network.

### BRIEF DESCRIPTION OF THE DRAWINGS

Illustrative embodiments of the present application are described in detail below with reference to the following drawing figures:

FIG. 1 is a diagram illustrating an example of an electronic device 100 used in Internet of Things (IoT) networks and includes a system-on-chip (SoC) 110 for performing various operations in accordance with some examples;

FIG. 2 is a sequence diagram illustrating an authentication using extensible authentication protocol (EAP) of a client device;

FIG. 3 is a block diagram of automated certificate-based device enrollment system 300 in accordance with some aspects of the disclosure;

FIG. 4 is a flow diagram illustrating a process for automatic wireless selection using Passpoint based on a certificate in accordance with some aspects of the disclosure;

FIG. 5 illustrates a sequence diagram of an automated certificate-based device enrollment system for generating certificates with embedded credential information in accordance with some aspects of the disclosure;

FIG. 6 is a flowchart illustrating an example process for generating and installing a CA certificate with authentication information in accordance with some aspects of the disclosure; and

FIG. 7 is a diagram illustrating an example of a system for implementing certain aspects of the present technology

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure may be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or may be learned by practice of the herein disclosed principles. The features and advantages of the disclosure may be realized and obtained by means of the instruments and combinations particularly pointed out in the appended claims. These and other features of the disclosure will become more fully apparent from the following description and appended claims, or may be learned by the practice of the principles set forth herein.

### Overview

Disclosed are systems, apparatuses, methods, computer readable medium, and circuits for an automated certificate-based device enrollment system. According to at least one example, a method includes: receiving, by a client device, a certificate signed by a certificate authority, the certificate including network credential information associated with a wireless network; in response to enabling a supplicant functionality on the client device, configuring a credential of the client device based on the certificate and the network credential information; triggering the automatic detection of the wireless network based on the network credential information and authenticating with the wireless network using the credential.

A client device (e.g., a wireless device) may, in response to enabling a supplicant functionality on the client device, configure a credential of the client device based on the certificate and the network credential information; triggering the automatic detection of the wireless network based on the network credential information and authenticate with the wireless network using the credential. In this way, the client device automatically provisions the credentials for connecting to the wireless network without any user input, allowing the client device to autonomously join a mutually authenticated wireless network without any user input.

In another example, an automated certificate-based device enrollment system is provided that includes a storage (e.g., a memory configured to store data, such as virtual content data, one or more images, etc.) and at least one processor (e.g., implemented in circuitry) coupled to the memory and configured to execute instructions and, in conjunction with various components (e.g., a network interface, a display, an output device, etc.), cause the apparatus to: receiving, by a client device, a certificate signed by a certificate authority, the certificate including network selection credential information identifying a wireless network and stored in a certificate attribute of the certificate. An example of a certificate attribute is a subject alternative name, which can support information that is validated with a URI. In other aspects, the certificate attribute can be defined based on a standard promulgated from a standards organization. In response to enabling a supplicant, the instructions may cause the apparatus to detect the network selection credential information in the certificate and configuring a credential of the client device based on the network selection credential information, trigger automatic detection and selection of the wireless network using the using the credential configured with the network selection credential information, and authenticate with the wireless network using the credential.

In another example, a non-transitory computer readable medium having instructions stored therein which, when executed by a processor, cause the processor to: receive a certificate signed by a certificate authority, the certificate including network selection credential information identifying a wireless network and stored in a certificate attribute of the certificate, in response to enabling a supplicant, detect the network selection credential information in the certificate and configure a credential of the client device based on the network selection credential information, trigger automatic detection and selection of the wireless network using the using the credential configured with the network selection credential information, and authenticate with the wireless network using the credential.

### EXAMPLE EMBODIMENTS

The following description is directed to certain implementations for the purposes of describing innovative aspects of various embodiments. However, a person having ordinary skill in the art will readily recognize that the teachings herein can be applied in a multitude of different ways. The described implementations can be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

Examples are described herein in the context of an automated certificate-based device enrollment system. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

Wireless authentication has evolved significantly over time to address growing security needs. Early wireless networks, such as those using Wired Equivalent Privacy (WEP), had basic encryption but were quickly found vulnerable. This led to the adoption of Wi-Fi Protected Access (WPA) and WPA2, which introduced stronger encryption with Temporal Key Integrity Protocol (TKIP) and Advanced Encryption Standard (AE). As networks expanded, the need for more robust authentication methods became clear, leading to the development of the 802.1X standard, which enabled the use of extensible authentication protocol (EAP) for flexible and secure authentication. Among EAP methods, EAP-transport layer security (EAP-TLS) emerged as a widely trusted approach due to its use of certificates for mutual authentication between clients and networks, ensuring stronger security by preventing unauthorized access through encryption and identity verification.

Another network discovery and authentication technique is Passpoint, a Wi-Fi alliance protocol. Passpoint defines a per-provider subscriber management object (PPSMO), which defines the configuration of a Passpoint end device that is designed to enable seamless network selection and subsequent secure authentication users. Passpoint configuration via a PPSMO typically requires a graphical user interface, such as through a web-browser-based authentication, or through another application to provide credentials. However, not all devices have graphical user interface capabilities (e.g., headless devices) and are single-purpose devices, such as sensors in an industrial automation setting.

The subject technology is related to improving authentication using PPSMO based Passpoint configuration by using a certificate authority (CA) certificate. In one illustrative aspect, the method includes receiving, by a client device, a certificate signed by a certificate authority. In this aspect, the certificate may include authentication information associated with a wireless network that is encoded into a field within the certificate. For example, the authentication information may be a public key credential which is associated with a private key that together can be used to access a wireless network based on an EAP-TLS mutual authentication. The CA may be instrumented with additional instructions to receive instructions from a requesting device to insert additional information, such as the authentication information (or network credentials). The client device generates a key pair and sends a certificate signing request to a CA. The CA generates the certificate that is signed by the CA that includes the public key of the client device that the certificate is installed upon. In addition, the certificate also embeds the information pertaining to network selection of a wireless network which is similarly signed by the CA.

A client device (e.g., a wireless device) may, in response to enabling a supplicant functionality on the client device, configure a credential of the client device based on the certificate and the network information and use the network information to seamlessly detect the wireless network, and authenticate with the wireless network using the credential. In this way, the client device automatically provisions the credentials for connecting to the wireless network without any user input, allowing the client device to autonomously join a mutually authenticated wireless network without any user input.

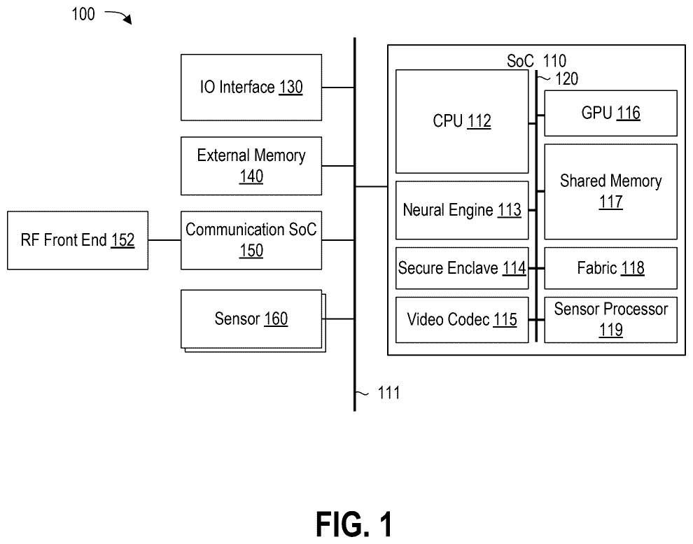

FIG. 1 is a diagram illustrating an example of an electronic device 100 used in IoT networks and includes a system-on-chip (SoC) 110 for performing various operations in accordance with some examples. In some aspects, the SoC 110 is connected to various components of the electronic device 100 using an interconnect bus 120 (e.g., a peripheral component interconnect (PCI), etc.). For example, the electronic device 100 includes an IO interface 130 for connecting to external interfaces. For example, the IO interface 130 can include a USB interface for interfacing with various external devices through a port (not shown). The electronic device 100 may also include an external memory 140 that is connected through the interconnect bus 120. In some cases, the external memory 140 may be connected to the SoC 110 through a memory interface such as a double data rate (DDR) memory bus.

The electronic device 100 may also include an communication SoC 150 including one or more integrated communication modules, modems, and other processing components. For example, the communication SoC 150 may include a modem for processing various signals of different standards (e.g., 802.11n, 802.11ax, 802.11be, Bluetooth™, etc.). The communication SoC 150 may be connected to an RF front end 152 to transmit and receive signals through the physical layer such as a lossy medium (e.g. air). In some cases, the communication SoC 150 also includes a wired network communication module.

The electronic device 100 may also have a sensor 160 to measure physical values and perform various functions of the electronic device 100. For example, the sensor 160 may be an image sensor for sensing visible or non-visible light to implement camera functions. Other non-limiting examples of sensors 160 include a biometric sensor (e.g., fingerprint sensor, iris sensor, etc.), a hall effect sensor, motion sensor (e.g., a gyrometer, an accelerometer, an inertial movement unit (IMU), etc.), an acoustic sensor, a luminance sensor, a temperature sensor, a humidity sensor, an infrared sensor, a magnetic sensor, etc.). For example, the sensor 160 may be installed in a home appliance, an industrial security system, a manufacturing system, a vehicle, and so forth.

In some cases, the sensor 160 can also be connected to additional components to detect the physical environment. For example, an image sensor can include a lens or a lens assembly positioned in front of a control mechanism, and light enters the image sensor through the lens which bends the light toward the sensor array, passes through the control mechanism, and then reaches a sensor array. When the image sensor is activated to capture a scene, the control mechanism opens a shutter to allow light to pass through to the sensor array. The control mechanism includes an aperture and is synchronized with the operation of a mirror (e.g., a DLSR camera) or an electronic shutter (e.g., a mirrorless camera) to ensure accurate exposure and focus. The control mechanism may control exposure, focus, and/or zoom based on information from the image sensor and/or based on information from an image signal processor (ISP). The control mechanism may include multiple mechanisms and components such as focal control, exposure control, zoom control, analog gain, flash, high dynamic range (HDR), depth of field, and/or other image capture properties.

The SoC 110 is a semiconductor device that is manufactured and configured to include various components to integrate functions within the SoC to reduce delays associated with external interfaces and other impediments. For example, the SoC 110 may include a bus 111 to facilitate efficient communication between various components within the SoC 110. In some examples, the bus 111 can include a 192-bit or 256-bit path to optimize data flow and provide a low-latency and high bandwidth data path between the various components described below.

In one aspect, the SoC 110 may include a central processing unit (CPU) 112 configured to execute arithmetic and logic software instructions. In some aspects, the CPU 112 comprises a plurality of processing cores that may be configured to execute the functionality in parallel, and the processing cores may have different configurations. For example, the CPU 112 may include a plurality of performance cores for low-latency functions and a plurality of efficiency cores that consume less power than the performance cores. The variety of cores enables the SoC 110 to parallelize tasks efficiently to ensure seamless operation of the various elements.

The SoC 110 may also include graphics components that are configured for various graphics operations and visualization. For example, a graphics processing unit (GPU) 116 may include a plurality of graphics processing cores for specialized processing such as floating-point math. In some cases, the GPU 116 can be designed by a third-party vendor and integrated into the SoC 110 using semiconductor manufacturing techniques. The GPU uses relevant data, such as vertices and textures, and processes the data in the graphic processing cores for parallel execution. In some cases, the graphics processing cores may also be referred to as shader cores. The graphics cores each perform complex mathematical computations such as vertex transformations, rasterization, fragment shading, and texture mapping to generate the final pixels of the rendered image, which may be displayed by the electronic device 100. The GPU 116 is optimized for floating point and vector mathematical operations such as warping, image analysis, and so forth.

The SoC 110 includes a neural engine 113 that includes a plurality of neural processing cores. A neural processing core includes arrays of multiply-accumulate (MAC) units and specialized instructions that are optimized for matrix operations, such as convolution and matrix multiplication. A neural processing core receives input data and performs matrix transformations and nonlinear activation functions to break down and parallelize matrix operations. The neural processing core is configured to perform tasks such as inference (e.g., runtime operation of a machine learning (ML) model) or training of deep learning models. For example, the neural engine 113 may perform computer vision tasks such as object recognition.

In some aspects, the SoC 110 may also include a shared memory 117 such as a random access memory (RAM) that is shared between the various components (e.g., CPU 112, GPU 116, neural engine 113, etc.). The SoC 110 may include additional hardware and software components to streamline memory allocation between the different components within the SoC 110.

The SoC 110 may also include a secure enclave 114 that is configured to secure the SoC 110 using various encryption techniques. The secure enclave may include encryption generation functionality, a true random number generator, a secure storage medium, and so forth. An example of a secure enclave 114 is a TPM module. In some cases, the SoC 110 or the secure enclave 114 may also be configured to interface with a security sub-system (not shown), such as a security module that is configured to securely store information that is not made available to the SoC 110. In one aspect, the security sub-system may securely store biometric information to enable various functions such as biometric authentication, etc.

The SoC 110 also includes a fabric 118 that is configured to facilitate interfacing the components of the SoC 110 internally and externally. As an example, the fabric 118 may include functionality to allocate the shared memory 117 between the various components within the SoC 110. The SoC 110 may interconnect the various components using a bus to enable access to the various components, such as enabling the CPU 112 to address a portion of the shared memory 117. In some aspects, the fabric 118 may also interface with external components such as a security sub-system, various bus interfaces (e.g., Peripheral Component Interconnect Express (PCI-e), thunderbolt, universal serial bus, a communication circuit for wireless communication, and so forth).

The SoC 110 may also include a video codec 115 (e.g., a video encoder and decoder) to encode raw video data and decode the encoded data for playback. The video codec 115 may be a hardware device due to increased efficiency, performance, power consumption, and advanced algorithms. In addition, hardware codecs ensure compatibility with a wide range of multimedia formats and standards to provide seamless playback and interoperability across different devices, applications, and services.

The SoC 110 can also include a sensor processor 119 for interfacing with the sensor 160 and processing input. A non-limiting example of a sensor processor is a motion processor that is configured to collect, process, and analyze data from various motion sensors, including accelerometers, gyroscopes, magnetometers, and sometimes barometers. The motion processor is configured to continuously monitor motion and orientation data to accurately detect changes in device orientation, track movement patterns, and enable features such as step counting, activity recognition, gesture control, and augmented reality experiences. The motion processor includes dedicated hardware that is configured to run with ultra-low power consumption and continually monitor and record data from the various sensors. Another example of a sensor processor 119 is an ISP that is configured to process light received from a sensor array to generate digital images.

The SoC 110 may also include one or more accelerated processing units that are configured to perform specific functions. For example, the SoC 110 may include DSPs, motion sensing co-processors, audio processors, network co-processors, wireless communication modules, touch control processors, and so forth.

The electronic device 100 illustrated in FIG. 1 is a headless device that does not include an integrated display. For example, the electronic device 100 can be an IoT sensor device that is deployed in a sensor network for building automation or manufacturing automation to control various aspects of the system. In this case, the electronic device 100 cannot be easily configured for interoperation within the premises based on a lack of ability for a person to input specific information such as network authentication credentials. For example, conventional EAP-TLS authentication is challenging without a screen to provide visual feedback.

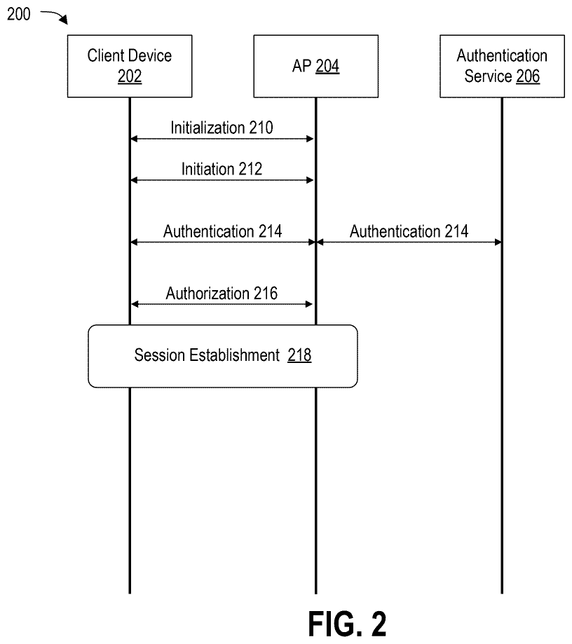

FIG. 2 is a sequence diagram 200 illustrating an authentication using extensible authentication protocol (EAP) of a client device 202. The client device 202 is commonly referred to as a supplicant during EAP-TLS processes. In some cases, the client device 202 may also be referred to as a wireless station or an STA in accordance with various 802.11x documents. In some aspects, the client device 202 is configured to connect to an access point (AP) 204, which authenticates the client device 202 via an authentication service 206, such as remote authentication dial-in user service (RADIUS).

Initially, the client device 202 initializes a connection with the AP 204 during an initialization 210 flow. In some cases, the client device 202 receives a beacon from the AP 204 which includes information to connect to the AP 204. In some cases, the information in the beacon includes Passpoint information. In other cases, the client device 202 may send a beacon and induce the AP 204 to send information to initiate the connection. After the initialization 210, the client device 202 compares the information received from AP 204 with its network configuration and if there is a match the client device 202 and AP 204 perform an initiation process 212 by exchanging messages such as an EAP start message and an EAP request identity message.

After the initiation process 212, the client device 202 and an authentication service 206 perform an authentication process 214 that exchanges authentication information to authenticate the client device 202 and ensure that user credentials and traffic are protected. The authentication process 214 includes the exchange of certificates from the authentication service 206 and the client device 202. For example, the AP 204 sends information that identifies the client device 202 (e.g., the supplicant) and the AP 204 (e.g., referred to as the authenticator in EAP-TLS) to the authentication service 206 to confirm their identity and allow for authenticating information to be sent. For example, the client device 202 may require the input of authentication credentials (e.g., via a touch screen).

In response, the authentication service 206 sends its server certificate to confirm its identity through server certificate validation, and the client device 202 validates the certificate, including the identity of the authentication server certificate. After validation, the client device 202 sends its client certificate to the authentication service 206. The authentication process 214 mutually validates the authenticity of both the client device 202 and the authentication service 206 to protect from both parties.

After the authentication process 214, the client device 202 and authentication service 206 perform an authorization process 216 that authorizes the client device 202 to access the AP 204, and then a session is established at block 218.

EAP-TLS authentication is a commonly used authentication mechanism but requires that the user provide credential information. Not all devices include the ability to allow the input of credential information easily. For example, IoT sensors may be embedded into different parts of a building or system to monitor various aspects and may be headless devices, or devices that do not include an integrated display. In some cases, the IoT devices are placed in or adjacent to extreme environments to monitor sensitive properties, such as the temperature of a furnace, that do not require a display for their primary function.

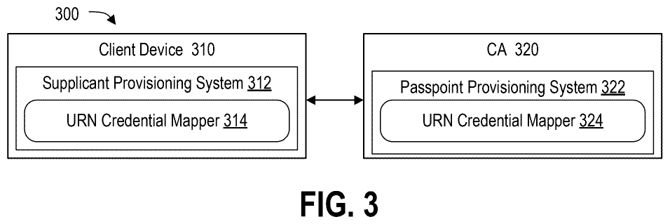

FIG. 3 is a block diagram of the automated certificate-based device enrollment system 300 in accordance with some aspects of the disclosure. In some aspects, the automated certificate-based device enrollment system 300 includes a client device 310 (e.g., an IoT device) and a CA 320 for generating and signing a certificate that includes a public key credentials for the device 310. The client device 310 includes a supplicant provisioning system 312 that includes a universal resource name (URN) network selection mapper 314. The CA 320 includes a Passpoint provisioning system 322 that includes a PPSMO network selection mapper.

In some aspects, the client device 310 is configured to request a certificate from the CA 320 as part of its initialization process. For example, during a manufacturing process or a device transfer process, the client device 310 may be put in a state to request the generate and signing of a certificate from the CA 320. In one aspect, the CA 320 is configured with information associated with a PPSMO to be used with certificate credentials issued to client device 310. For example, the information associated with the PPSMO may include a realm, a username, a domain, a domain suffix, and so forth.

In some cases, the CA 320 may be instrumented with the authentication credentials using an out-of-band process. For example, an administrator of the client device can interact with a client application of the CA 320 (e.g., a web application) and insert information to cause the CA 320 to add network selection credentials to the certificate. In this case, the certificate request can include an option to instruct the CA 320 to insert the network selection credentials. In other cases, the certificate request itself may include credentials (e.g., an in-band request). For example, the request can include a flag that attaches a file to the request that the CA 320, and the file may have the network selection credentials.

In one aspect, the Passpoint provisioning system 322 may be configured to generate a certificate including a PPSMO configuration. For example, the CA 320 can be instrumented with additional instructions to look for a flag (e.g., an option) that requests additional information be encoded in the certificate. In still other embodiments, the CA 320 can be instrumented to look for a flag represented by a value of a particular attribute in the certificate signing request received from the supplicant provisioning system 312. In still other embodiments, a plurality of flags may be defined, one of which is included in the request to indicate hot the CA 320 should configure the PPSO configuration within the certificate. The Passpoint provisioning system 322 may generate the certificate and encode the information associated with the PPSMO into the certificate, which implicitly binds the validation of the certificate with the information associated with the PPSMO.

In one aspect, the Passpoint provisioning system 322 includes a network selection mapper 324 that maps the information associated with the PPSMO into the certificate. For example, the network selection mapper 324 may encode key-value pairs into a subject alternative name (SAN) field. The SAN field is validated based on a URI, and a URN is a valid URI. In this case, the network selection mapper 324 can encode the information associated with the PPSMO (e.g., username=anonymous; realm=onboarding.widgets.com) into the SAN field. In other aspects, a reserved field or new property can be introduced into the certificate for mapping PPSMO information. The CA 320 issues the certificate to the client device 310. In other examples, the network selection mapper 324 may encode key-value pairs into a well know certificate attribute designated as encoding PPSMO information. In this case, the network selection mapper 324 can encode the information associated with the PPSMO into an abstract syntax notation one (ASN.1) string in the certificate attribute.

The client device 310 includes a supplicant provisioning system 312 to provision the client device 310 with credentials when requested. For example, during authentication (e.g., with an authenticator such as an AP and an authorization service such as RADIUS), the supplicant provisioning system 312 may be configured to recover network selection credentials, such as the PPSMO information from a certificate issued by a Passpoint provisioning system 322. In the event that the client device 310 uses the PPSMO information to identify a wireless network, the supplicant provisioning system 312 loads and processes the certificate in order to complete an EAP authentication exchange with the wireless network. In one aspect, the URN network selection mapper 314 is configured to identify encoded network selection credentials in a field (e.g., the SAN) and automatically use the network selection credentials to automatically identify a wireless network and to use the certificate signed public key in the corresponding EAP communications. In this manner, the client device 310 may autonomously identify a wireless network and transmit the authentication credentials that are encoded into the certificate.

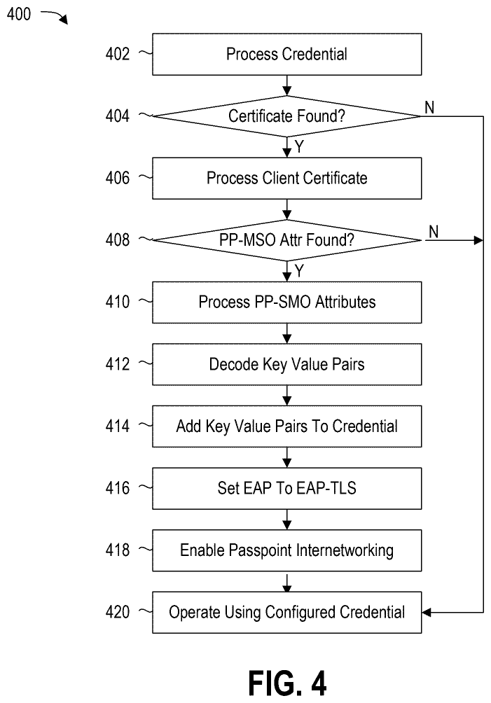

FIG. 4 is a flow diagram 400 illustrating a process for automatic wireless selection using Passpoint based on a certificate in accordance with some aspects of the disclosure. In some aspects, the flow diagram 400 may be performed on a client device as part of an authentication.

At block 402, the client device may determine to process credentials in connection with joining a wireless network. For example, the client device may be configured to automatically enable its supplicant functionality immediately following power on.

At block 404, the client device may search for a CA issued certificate including network selection credentials, a private key, and other information. If no CA issued certificate is identified, the client device proceeds to block 420 and operates using another stored credential if available, or does not connect to the wireless network if no credentials are available. If the CA issued certificate is available, the client device proceeds to block 406.

At block 406, the client device processes the CA issued certificate. For example, the client device may validate the authenticity of the CA issued certificate based on the encrypted signature and the public key of the CA.

At block 408, the client device searches for PPSMO information encoded in a the CA issued certificate. For example, the client device may search the SAN for a URN that is encoded with keys having names corresponding to a PPSMO using standard mapping of key names (e.g., camel case, pascal case, kebab case, snake case, etc.). In other examples, the client device may be configured to search for a specific certificate attribute used for encoding the PPSMO where the certificate attribute encodes an abstract syntax notation one (ASN.1) string using standard mapping of key names. The client device may use the setting of its flag requesting inclusion of the certificate PPSMO attribute in configuring which certificate attribute to search for PPSMO information. If the client device does not identify PPSMO information, the client device proceeds to block 420 and operates using a stored credential if available, or does not connect to the wireless network if no credentials are available. If PPSMO information is available, the client device proceeds to block 410.

At block 410, the client device identifies the PPSMO information encoded in a certificate attribute in the certificate (e.g., in the SAN field or other well known certificate attribute), the client device processes the PPSMO attribute and, at block 412, decodes the key-value pairs in the attribute to yield the PPSMO information as key-value pairs.

At block 414, the client device adds the key-value pairs to the network selection credential. At block 416, the client device sets the EAP connection mode to EAP-TLS to mutually authenticate based on the certificate. At block 418, the client device enables Passpoint internetworking to automatically search for wireless networks based on the PPSMO information without any user intervention. For example, at block 418, a headless client device is automatically configured to join a wireless network that is identified in the certificate.

After the client device enables Passpoint internetworking, the client device is configured to operate using the PPSMO and configured credential. In this case, the client device is configured to automatically search for wireless networks based on PPSMO information and, when there is a matching network identified, mutually authenticate in response to a specific configuration identified in the CA issued certificate.

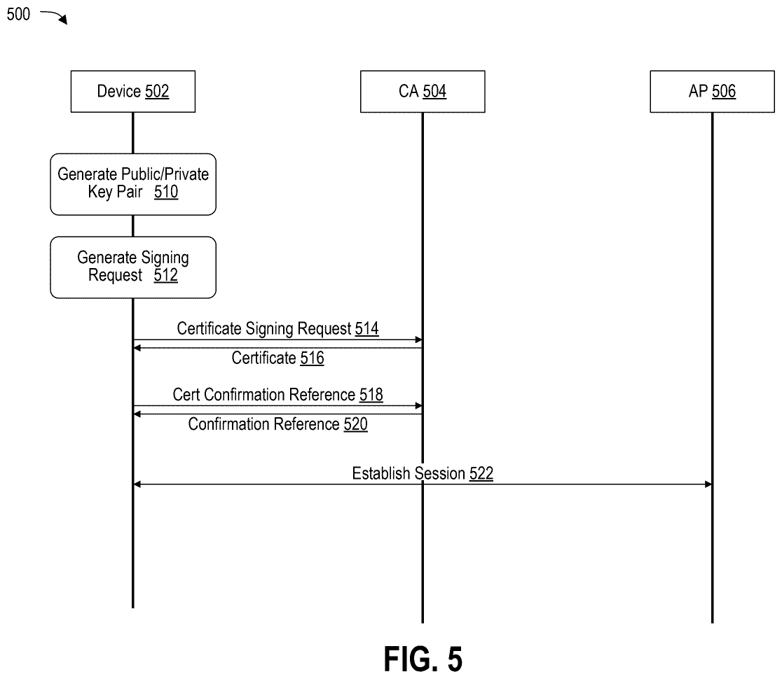

FIG. 5 illustrates a sequence diagram 500 of an automated certificate-based device enrollment system for generating certificates with embedded network selection credential information in accordance with some aspects of the disclosure. The sequence diagram 500 illustrates a client device 502 requesting a certificate from a CA 504 and then subsequent session establishment with an AP 506 (e.g., with an authenticator such as a RADIUS).

At block 510, the client device 502 receives an instruction to generate a public/private key pair. For example, the client device 502 may be connected to manufacturing system provisioning of manufacturing installed certificate (MIC). The client device 502 may also be connected to a calibration system for connecting to and configuring headless devices in an IoT network. The client device 502 generates a public/private key pair using, for example, a random number generator that generates a strong prime number that ensures cryptographic security. The client device 502 may then generate a certificate signing request at block 512. The certificate signing request may include additional information, such as a request to encode PPSMO credentials in the certificate. In one example, the client device 502 generates a certificate signing request that includes a policy object identifier that identifies a certificate policy describing the encoding of PPSMO credentials in a certificate.

At block 514, the client device 502 is configured to transmit the certificate signing request to the CA 504, which generates and signs the certificate 516. In some aspects, the CA 504 may be configured to check the block 514 for supplemental information and include PPSMO credentials. For example, the CA 504 may generate a certificate attribute based on key-value pairs associated with the PPSMO credentials of a wireless network. The CA 504 transmits a certificate 516 to the client device 502 in response to the block 514 and the client device 502 stores the certificate. In some cases, the client device 502 may transmit a certificate confirmation reference 518 to validate the certificate, and the/504 responds with a confirmation reference 520.

After installation of the signed certificate, the client device 502 executes a process (e.g., the process illustrated in FIG. 4) to autonomously search, select and authenticate with a wireless network. In this case, the client device 502 is autonomously provisioned with the PPSMO credentials based on receiving the certificate 516. For example, the client device 502 may use the PPSMO credentials to search for wireless networks that are configured with PPSMO information that matches the information encoded in the certificate. This matching of PPSMO information triggers the automatic establishment of session 522. The certificate 516 is necessary to validate with the AP 506, and converging the certificate issuance process and the PPSMO provisioning process into a single process simplifies the deployment of the client device 502 into the network.

The objects below illustrates a credential object of type Credential in structured form that is stored within the client device 502, and a provisioned object of type ProvisionedCredential that includes the authentication credentials from the CA certificate. For example, the provisioned object includes PPSMO authentication credentials.

```
C1: Credential = {
  ca_cert = “/etc/ssl/certs/ca.pem”
  client_cert= “/etc/ssl/certs/client.pem”
  private_key = “/etc/ssl/certs/client.key”
  private_key_passwd = “string”
}
C2: ProvisionedCredential = {
  ca_cert = “/etc/ssl/certs/ca.pem”
  client_cert= “/etc/ssl/certs/client.pem”
  private_key = “/etc/ssl/certs/client.key”
  private_key_passwd = “string”
  realm= “onboarding.widget.com”
  roaming_consortium= “5a03ba00000, 5a03ba0a00”
  eap=TLS
  username=“anonymous”
  priority=255
  domain=“onboarding.widget.com”
  domain_suffix_match= “widget-manufacturer.com”
  home_ois= “00000c”
  excluded_ssid= “competitor-ssid”
}
```

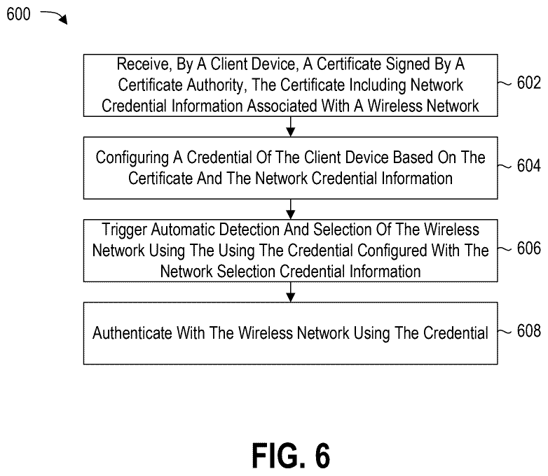

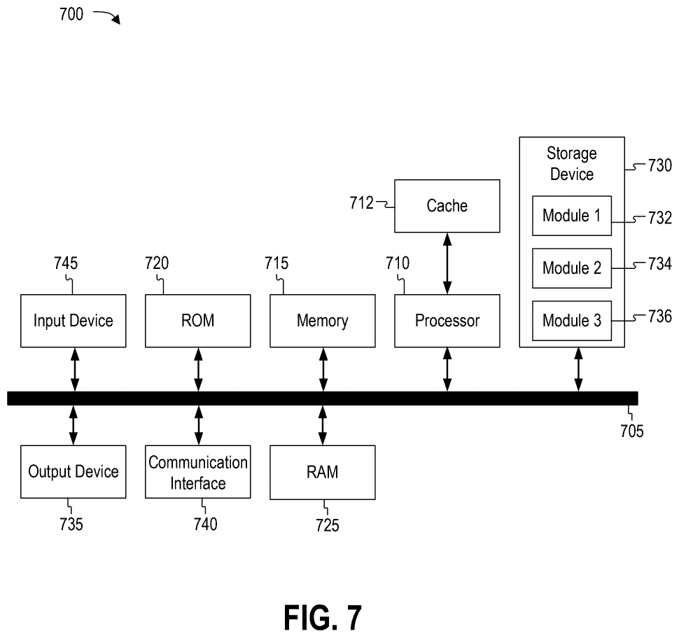

FIG. 6 is a flowchart illustrating an example process 600 for generating and installing a CA issued certificate with additional authentication information in accordance with some aspects of the disclosure. The process 600 can be performed by a computing device (or apparatus) or a component (e.g., one or more chipsets, an SoC, one or more processors such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., an ML system such as a neural network model, any combination thereof, and/or other component or system) of the computing device. The operations of the process 600 may be implemented as software components that are executed and run on one or more processors (e.g., CPU, GPU, DSP, NPU or neural engine, SoC, the processor 710 of FIG. 7, and/or other processor(s)).

At block 602, the computing device is configured to receive a certificate signed by a certificate authority, the certificate including network selection credential information associated with a wireless network. The network selection credential information includes the information that enables the automatic identification of the wireless network and includes sufficient information to authenticate with the wireless network without user input. In one aspect, the computing device is headless (e.g., does not include a display). In some cases, the computing device may omit conventional types of input associated with a general-purpose computer (e.g., a keyboard/mouse can be excluded) as the computing device is a single-use device, such as a security camera or a temperature sensor.

In one aspect, the network selection credential information is stored in a SAN field of the certificate. For example, the network selection credential information is stored as a (URN) within the subject alternative name field. In one example, the network selection credential information includes properties of a PPSMO and allows the computing device to seamlessly detect a wireless network using the Passpoint specification.

In another aspect, the certificate can be extended to include a certificate attribute. In this case, the certificate includes a certificate attribute where the certificate attribute encodes an abstract syntax notation one (ASN.1) string using standard mapping of key names. In one case, the certificate attribute encodes at least a realm associated with the credential issuer and a Passpoint attribute to enable the automatic selection of a wireless network. For example, ASN.1 is a data structure that can be serialized and transmitted across different platforms and systems and supports different types of data structures (e.g., a hierarchical tree, arrays, key value pairs, etc.). In other cases, the certificate attribute may include other information defined in PPSMO object, or another field can be used with a URN.

At block 604, the computing device is configured to configure a credential of the client device based on the certificate and the network selection credential information. In some aspects, the configuring of the credential can happen before detecting of the network (e.g., upon initialization of the wireless communication device). Configuring the credential triggers the communication device to perform automatic wireless network selection based on the configured network credential. In one case, the wireless communication device uses PPSMO defined information stored in the certificate to search for wireless networks according to the Passpoint specification. In some aspects, at block 604, the detecting of the network selection credential information can be in response to enabling a supplicant. A supplicant is software or a client component that requests network access by authenticating with the access point or server and is responsible for handling the authentication process on behalf of the device (e.g., by authenticating with an authentication server using protocols such as EAP).

At block 606, the computing device may trigger automatic detection and selection of the wireless network using the using the credential configured with the network selection credential information. At block 606, the computing device can be configured to scan for wireless (e.g., by sending beacons) and/or based on proximity to other devices (e.g., by receiving beacons from a broadcasting device).

At block 608, the computing device has identified a wireless network and is configured to authenticate with the wireless network using the credential. For example, the certificate is provided to an authentication service as part of an EAP-TLS authentication.

In one aspect, to authenticate at block 608, the computing device may receive a second certificate signed by the certificate authority and associated with an authentication service. The computing device authenticates the second certificate to authenticate the client device to access the wireless network.

After authentication at block 608, the computing device is authenticated with the wireless network and may establish a session (e.g., with an AP) and begin communication with other devices in the system (e.g., an IoT controller).

FIG. 7 is a diagram illustrating an example of a system for implementing certain aspects of the present technology. In particular, FIG. 7 illustrates an example of computing system 700, which may be for example any computing device making up internal computing system, a remote computing system, a camera, or any component thereof in which the components of the system are in communication with each other using connection 705. Connection 705 may be a physical connection using a bus, or a direct connection into processor 710, such as in a chipset architecture. Connection 705 may also be a virtual connection, networked connection, or logical connection.

In some embodiments, computing system 700 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 700 includes at least one processing unit (CPU or processor) 710 and connection 705 that communicatively couples various system components including system memory 715, such as ROM 720 and RAM 725 to processor 710. Computing system 700 may include a cache 712 of high-speed memory connected directly with, in close proximity to, or integrated as part of processor 710.

Processor 710 may include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which may represent any number of input mechanisms, such as a microphone for speech, a touch-sensitive screen for gesture or graphical input, keyboard, mouse, motion input, speech, etc. Computing system 700 may also include output device 735, which may be one or more of a number of output mechanisms. In some instances, multimodal systems may enable a user to provide multiple types of input/output to communicate with computing system 700.

Computing system 700 may include communications interface 740, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 730 may include software services, servers, services, etc., that when the code that defines such software is executed by the processor 710, it causes the system to perform a function. In some embodiments, a hardware service that performs a particular function may include the software component stored in a computer-readable medium in connection with the necessary hardware components, such as processor 710, connection 705, output device 735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (<) and greater than (>) symbols or terminology used herein may be replaced with less than or equal to (“s”) and greater than or equal to (“>”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. A method comprising: receiving, by a client device, a certificate signed by a certificate authority, the certificate including network selection credential information identifying a wireless network and stored in a certificate attribute of the certificate; in response to enabling a supplicant, detecting the network selection credential information in the certificate and configuring a credential of the client device based on the network selection credential information; triggering automatic detection and selection of the wireless network using the using the credential configured with the network selection credential information; and authenticating with the wireless network using the credential.
Aspect 2. The method of Aspect 1, wherein the network selection credential information includes properties of a per-provider subscriber management object.
Aspect 3. The method of any of Aspects 1 to 2, wherein the certificate attribute comprises a universal resource name within the subject alternative name field.
Aspect 4. The method of any of Aspects 1 to 3, wherein the certificate is provided to an authentication service as part of an extensible authentication protocol-transport security layer (EAP-TLS) authentication.
Aspect 5. The method of any of Aspects 1 to 4, further comprising: receiving a second certificate signed by the certificate authority and associated with an authentication service, wherein the client device authenticates the second certificate to authenticate the client device to access the wireless network.
Aspect 6. The method of any of Aspects 1 to 5, wherein the client device is headless.
Aspect 7. The method of any of Aspects 1 to 6, wherein the certificate includes a credential field a realm associated with a certificate credential and a Passpoint attribute for enabling the automatic detection and selection of the wireless network.
Aspect 8. The method of any of Aspects 1 to 7, wherein the network selection credential information is stored as the certificate attribute encoded as an Abstract Syntax Notation number one (ASN.1) string.
Aspect 9. The method of any of Aspects 1 to 8, wherein automatic detection and selection of the wireless network is based on a Passpoint specification.
Aspect 10. The method of Aspect 1, wherein the network selection credential information is stored in the certificate based on a standard provided by a standards organization.
Aspect 11. A computing device including a wireless communication device and at least one processor coupled to the wireless communication device and configured to: receive a certificate signed by a certificate authority, the certificate including network selection credential information identifying a wireless network and stored in a certificate attribute of the certificate, in response to enabling a supplicant, detect the network selection credential information in the certificate and configure a credential of the client device based on the network selection credential information, trigger automatic detection and selection of the wireless network using the using the credential configured with the network selection credential information, and authenticate with the wireless network using the credential.
Aspect 12. The computing device of Aspect 11, wherein the network selection credential information includes properties of a per-provider subscriber management object.
Aspect 13. The computing device any of Aspects 11 to 12, wherein the certificate attribute comprises a universal resource name within a subject alternative name field.
Aspect 14. The computing device of any of Aspects 11 to 13, wherein the certificate is provided to an authentication service as part of an extensible authentication protocol-transport security layer (EAP-TLS) authentication.
Aspect 15. The computing device of any of Aspects 11 to 14, wherein the at least one processor is configured to: receive a second certificate signed by the certificate authority and associated with an authentication service, wherein the client device authenticates the second certificate to authenticate the client device to access the wireless network.
Aspect 16. The computing device of any of Aspects 11 to 15, wherein the client device is headless.
Aspect 17. The computing device of any of Aspects 11 to 16, wherein the certificate includes a network selection credential field for including at least one of a username for the wireless network and a realm associated with the wireless network.
Aspect 18. The computing device of any of Aspects 11 to 17, wherein the network selection credential information is stored as the certificate attribute encoded as an Abstract Syntax Notation number one (ASN.1) string.
Aspect 19. The computing device of any of Aspects 11 to 18, wherein the automatic detection and selection of the wireless network is based on a Passpoint specification.
Aspect 20. The computing device of any of Aspects 11 to 19, wherein the network selection credential information is stored in the certificate based on a standard provided by a standards organization.
Aspect 21. A non-transitory computer-readable medium having stored thereon instructions that, when executed by at least one processor, cause the at least one processor to perform operations according to any of Aspects 1 to 10.
Aspect 22. An apparatus, comprising one or more means for performing operations according to any of Aspects 1 to 10.

What is claimed is:

1. A method comprising:
receiving, by a client device, a certificate signed by a certificate authority, the certificate including network selection credential information identifying a wireless network and stored in a certificate attribute of the certificate;
in response to enabling a supplicant, detecting the network selection credential information in the certificate and configuring a credential of the client device based on the network selection credential information;
triggering automatic detection and selection of the wireless network using the using the credential configured with the network selection credential information; and authenticating with the wireless network using the credential.

2. The method of claim 1, wherein the network selection credential information includes properties of a per-provider subscriber management object.

3. The method of claim 1, wherein the certificate attribute comprises a universal resource name within a subject alternative name field.

4. The method of claim 1, wherein the certificate is provided to an authentication service as part of an extensible authentication protocol-transport security layer (EAP-TLS) authentication.

5. The method of claim 1, further comprising:
receiving a second certificate signed by the certificate authority and associated with an authentication service, wherein the client device authenticates the second certificate to authenticate the client device to access the wireless network.

6. The method of claim 1, wherein the client device is headless.

7. The method of claim 1, wherein the certificate includes a realm associated with a certificate credential and a Passpoint attribute for enabling the automatic detection and selection of the wireless network.

8. The method of claim 1, wherein the network selection credential information is stored as the certificate attribute encoded as an Abstract Syntax Notation number one (ASN.1) string.

9. The method of claim 1, wherein automatic detection and selection of the wireless network is based on a Passpoint specification.

10. The method of claim 1, wherein the network selection credential information is stored in the certificate based on a standard provided by a standards organization.

11. A client device, comprising:
a wireless communication device; and
at least one processor coupled to the wireless communication device and configured to:
receive a certificate signed by a certificate authority, the certificate including network selection credential information identifying a wireless network and stored in a certificate attribute of the certificate;
in response to enabling a supplicant, detect the network selection credential information in the certificate and configure a credential of the client device based on the network selection credential information;
trigger automatic detection and selection of the wireless network using the using the credential configured with the network selection credential information; and
authenticate with the wireless network using the credential.

12. The client device of claim 11, wherein the network selection credential information includes properties of a per-provider subscriber management object.

13. The client device of claim 12, wherein the certificate attribute comprises a universal resource name within a subject alternative name field.

14. The client device of claim 11, wherein the certificate is provided to an authentication service as part of an extensible authentication protocol-transport security layer (EAP-TLS) authentication.

15. The client device of claim 11, wherein the at least one processor is configured to:
receive a second certificate signed by the certificate authority and associated with an authentication service, wherein the client device authenticates the second certificate to authenticate the client device to access the wireless network.

16. The client device of claim 11, wherein the client device is headless.

17. The client device of claim 11, wherein the certificate includes a realm associated with a certificate credential and a Passpoint attribute for enabling the automatic detection and selection of the wireless network.

18. The client device of claim 11, wherein the network selection credential information is stored as the certificate attribute encoded as an Abstract Syntax Notation number one (ASN.1) string.

19. The client device of claim 11, wherein the automatic detection and selection of the wireless network is based on a Passpoint specification.

20. The client device of claim 11, wherein the network selection credential information is stored in the certificate based on a standard provided by a standards organization.
